(19) United States
(12) Patent Application Publication
(10) Pub. No.: US 2005/0211743 A1
(43) Pub. Date: Sep. 29, 2005

(54) Tape detector device for dispenser

(76) Inventor: Martine Mandar, Le Chesnay (FR)

Correspondence Address: CHRISTIE, PARKER & HALE, LLP, PO BOX 7068, PASADENA, CA, 91109-7068, US

(21) Appl. No.: 10/514,767

(22) PCT Filed: May 5, 2003
(86) PCT No.: PCT/FR03/01391

§ 371 Date: Nov. 16, 2004

(30) Foreign Application Priority Data
May 17, 2002 (FR) 02/06118

(51) Int. Cl. B26F 3/02

(52) U.S. Cl. 225/56

(57) ABSTRACT

The invention relates to a device for the automatic selection of rolls of tape, particularly adhesive tapes, which are used in dispensers. The inventive device ensures that a dispenser uses certain types of tape rolls selectively by preventing unsuitable rolls from being placed correctly therein or from rotating. According to the invention, lugs (62) which surround the mandrel (63) of the dispenser only allow a tape core having a corresponding annular groove on one of the sides thereof to be positioned correctly in the dispenser and to rotate.

The present invention relates to a dispenser for rolls of tape. A roll of tape is wound onto a hub referred to as a core. The core is hollow through its centre.

A dispenser includes several components. These components include
a main structure which can be made of one or several parts and capable of supporting, covering, protecting or ballasting the tape,
a mandrel designed to receive a tape roll,
a cutting system enabling the tape to be cut to the desired length.

In a non-limitative manner, the mandrel can be formed so as to cooperate with the dispenser in two different ways known in the existing state of the art.

This mandrel can be connected to the main structure, referred to as the supporting structure, in a manner such that it cannot rotate on its axis: this case will be referred to as “non-rotating mandrel”.

This covers the case of a mandrel connected in a rigid manner to the supporting structure. This also covers the case of a mandrel capable of being fitted to the supporting structure but which can rotate on its axis only when it is in the normal operating position.

In the case of dispensers with non-rotating mandrel when the tape roll is in position in the dispenser, the roll core must be able to rotate about the mandrel so as to permit unwinding of the tape.

The mandrel can also be connected to the supporting structure so that, when it is in the normal operating position, it is able to rotate about its axis; for example, it can be supported in notches provided in the supporting structure: this case will be referred to as “rotating mandrel”.

In this case, when the roll is in position in the dispenser, it is not necessary for the core to be able to rotate about the mandrel, even if this is often the case, because the mandrel, and therefore also the core, can rotate about its axis to allow the tape to unwind.

In the same category of application (medical, fixing, packing, etc.), it is possible to use several different tapes corresponding to specific applications
the category of medical applications can include tapes providing for different medical needs,
the category of adhesive tapes can include a wide range of fixing tapes, some with permanent hold, others repositionable, etc.

The core diameters are often identical in each application category, by reason of the constraints on adjustment of the tape winding machines. The various tapes can therefore be dispensed by the same dispenser, hence there is a risk of error in selecting the tape to be used.

This can have serious consequences: for the patient who receives an unsuitable dressing; for the draughtsman who uses a permanent-fix tape on his drawings where a repositionable test was needed, etc.

Naturally, it is possible to leave it to the operator to check the grade of tape used, for example by the markings on the tape packaging. However it would be preferable, or even recommended, to be able to rely on a system of “passive” safety which does not depend on possible operator error or training, but which has a certain automatic character.

The invention aims to improve this situation.

The invention relates to a dispenser and tape roll combination, the dispenser including a supporting structure defining an axis X, and a mandrel extending on axis X and receiving a core carrying the tape roll so as to allow the latter to rotate on itself about the axis X. In a principal characteristic of the invention, the dispenser includes detection means facing at least one side of the core, said detection means and said side respectively presenting projections and/or gaps and gaps and/or projections positioned and dimensioned so as to facilitate the insertion and rotation of the core in the dispenser, the detection means preventing the insertion or rotation of a core having a side that is not compatible with the detection means.

According to a particular characteristic of the invention, the detection means incorporate a wall substantially perpendicular to the axis X presenting in one of its faces, turned towards the mandrel, at least one gap receiving a suitable projection formed on a side of the core, said wall preventing the insertion or rotation of a core having an unsuitable projection.

According to another particular characteristic of the invention, the detection means incorporate at least one projection engaging, substantially parallel to the axis X, in a suitable gap provided in a side of the core.

The invention also relates to a tape roll dispenser designed to form part of the dispenser and tape roll combination. The dispenser includes a support structure defining an axis X, and a mandrel extending on the axis X and capable of receiving a core carrying a tape roll, so as to allow the latter to rotate on itself about the axis X, the dispenser including detection means positioned radially beyond the mandrel relative to the axis X and designed to cooperate with the core so as to enable the latter to be inserted or to rotate correctly in the dispenser only if it has a shape compatible with the detection means.

According to an advantageous characteristic of the invention, the detection means incorporate a wall substantially perpendicular to the axis X presenting in one of its faces, turned towards the mandrel, at least one gap designed to receive a suitable projection formed on a side of the core, said wall preventing the insertion or rotation of a core having an unsuitable projection.

According to another advantageous characteristic of the invention, the detection means incorporate at least one projection designed to engage, substantially parallel to the axis X, in a suitable gap provided in a side of the core.

According to a particular embodiment, the projection includes at least one lug.

According to another particular embodiment, the projection includes at least one tube portion of axis X.

According to a variant of the invention, the mandrel is mounted on the supporting structure so as to rotate about the axis X.

According to a particular embodiment, the mandrel includes at least one arm carrying the projection.

In another particular embodiment, the mandrel includes a disc extending perpendicularly to the axis X and incorporating detection means.

According to a variant of the invention, at least one part of the detection means is integral with the supporting structure.

According to another variant of the invention, at least one part of the detection means is integral with the mandrel.

The invention also relates to a tape roll designed to form part of the dispenser and tape roll combination. This tape roll includes a core of which at least one side presents at least one projection extending substantially axially and designed to engage in a gap in a wall of the dispenser.

In an advantageous embodiment, at least one side of the core presents at least one gap designed to receive a projection on the dispenser.

In another advantageous embodiment, the projection includes at least one lug.

In an alternative embodiment, the projection includes at least one tube portion of axis X.

Other characteristics and advantages of the invention will become apparent in light of the detailed description below and the attached drawings in which:

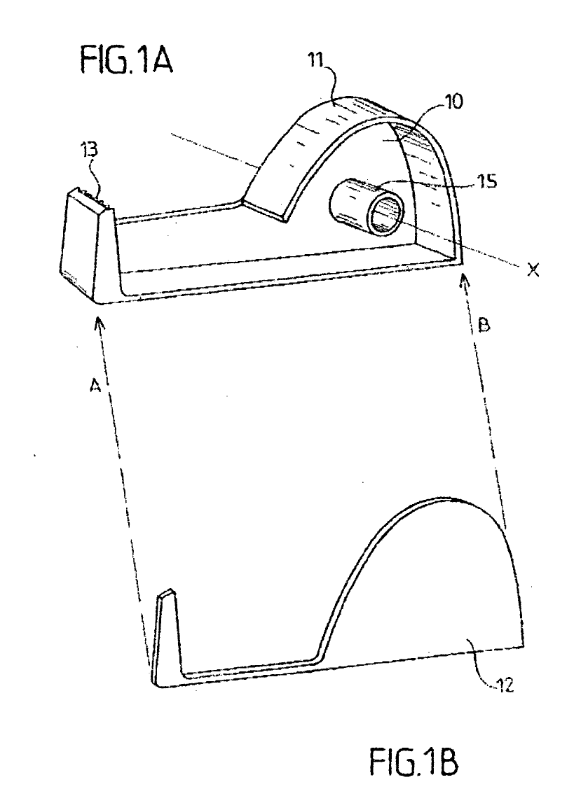

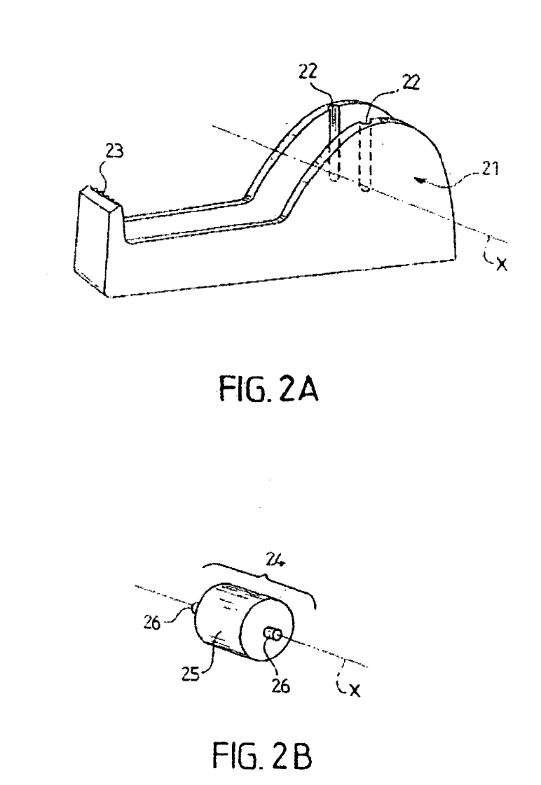

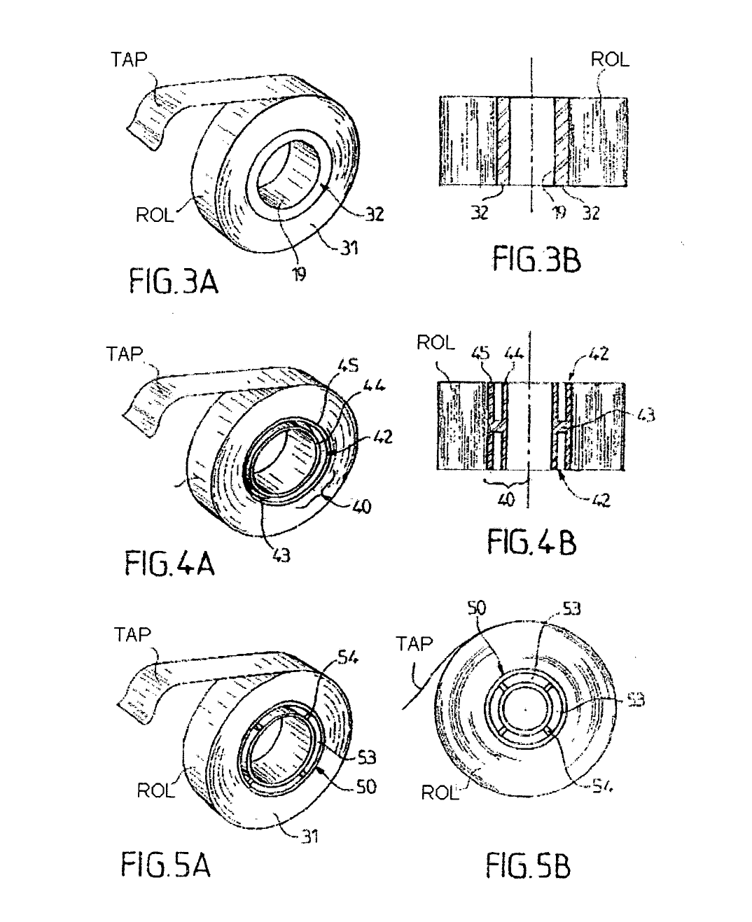

FIGS. 1A and 1B illustrate an embodiment according to the prior art of a dispenser formed in two complementary parts including a fixed mandrel for a tape roll;
FIGS. 2A and 2B illustrate an embodiment according to the prior art of a dispenser formed by a one-piece supporting structure cooperating with a rotating mandrel for a tape roll;
FIG. 3A depicts a core of a tape roll according to a first embodiment of the prior art;

FIG. 3B depicts a sectional view of the core of a tape roll according to the first embodiment in FIG. 3A;

FIG. 4A depicts a core of a tape roll according to a second embodiment of the prior art;

FIG. 4B depicts a sectional view of the core of a tape roll according to the second embodiment in FIG. 4A;

FIG. 5A depicts a core of a tape roll according to a third embodiment;

FIG. 5B depicts a sectional view of the core of a tape roll according to the third embodiment in FIG. 5A;

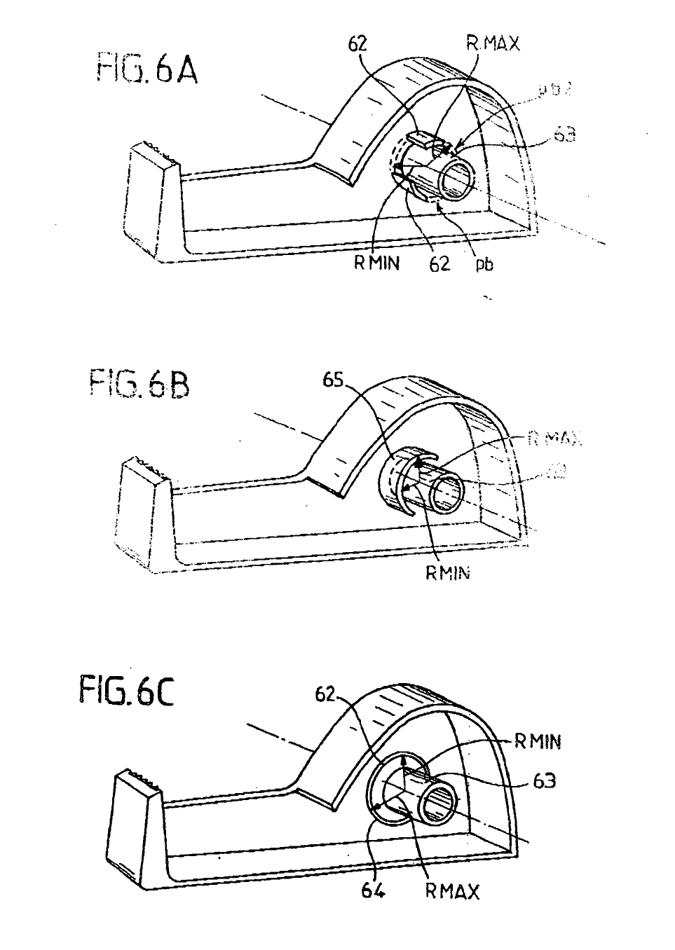

FIG. 6A illustrates a first embodiment of a non-rotating mandrel according to the invention;

FIG. 6B illustrates a second embodiment of a non-rotating mandrel according to the invention;

FIG. 6C illustrates a third embodiment of a non-rotating mandrel according to the invention;

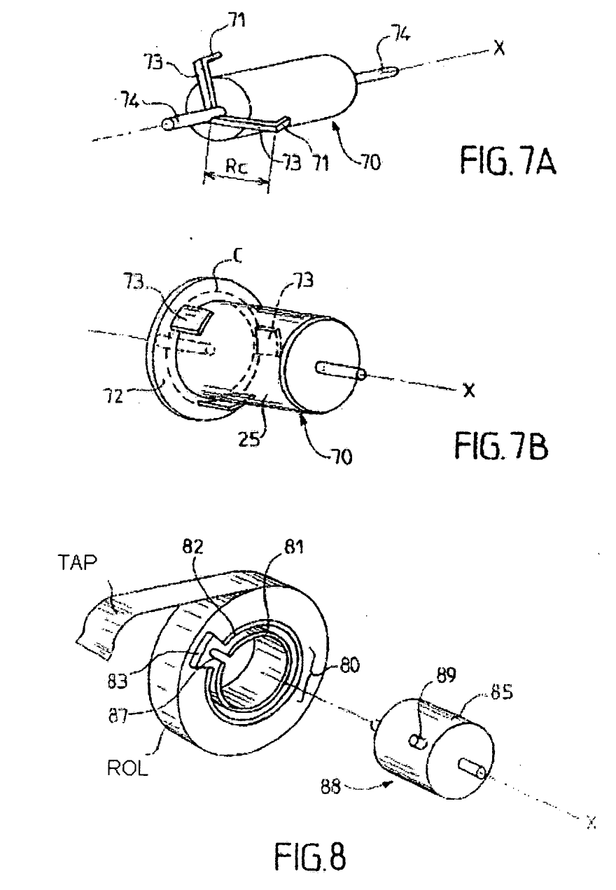

FIG. 7A illustrates a first embodiment of a rotating mandrel according to the invention;

FIG. 7B illustrates a second embodiment of a rotating mandrel according to the invention; and

In reference to FIGS. 1A and 1B, a dispenser for a tape roll, in particular an adhesive tape, comprises a casing including a first casing part 11 according to FIG. 1A, and a second casing part 12 according to FIG. 1B. These first and second casing parts can advantageously be screwed or slotted together in the direction of arrows A and B.

In the example in FIG. 1A, the first casing part 11 forming part of the supporting structure includes a cutting system 13 enabling the tape to be cut to the desired length, and a fixed mandrel, for example of cylindrical shape 15 of axis X designed to receive a core of a tape roll inserted from the free end of the mandrel and capable of rotating on itself about the axis X. The fixed mandrel 15 is attached to a wall 10 of the first casing part, the wall 10 being perpendicular to the axis X. Once the core of a tape roll is placed on the cylindrical mandrel, the second casing part 12 is attached to the first casing part in FIG. 1A to form a complete dispenser and containing a tape roll. In this example, the mandrel can be a fixed part of the supporting structure or a part added and fixed to the supporting structure to form a non-rotating mandrel.

FIGS. 2A and 2B depict another type of dispenser wherein the supporting structure 21 is in one piece and is fitted with a cutting device 23. The supporting structure of the dispenser respectively includes opposing slots 22 defining an axis X so as to receive a rotating mandrel 24, as shown in FIG. 2B, designed to rotate on itself about the axis X.

This rotating mandrel 24 comprises a mandrel formed by a central cylinder 25 around which the core of a tape roll is made to slide. It is provided with two projections 26 on its axis X, which are inserted into the slots 22 and enable the rotating mandrel to turn freely about the axis X.

During manufacture, the tape is wound around the core. At first use of the roll thus formed, the core is slid onto the mandrel. During use,
either the core and the tape rotate about the non-rotating mandrel (for example fixed)
or the core, the tape and the mandrel rotate together (rotating mandrel).

Various embodiments of tape rolls, or more precisely tape cores, are described in reference to FIGS. 3A, 3B, 4A, 4B, 5A, 5B. Thus, the tape roll ROL includes a core around which is wound a tape 31 having a free end TAP.

According to FIGS. 3A and 3B, a core 19 of a tape roll presents solid sides 32, meaning that the core has no openings in its sides 32.

FIGS. 4A and 4B illustrate a second embodiment of a core 40 and a wound tape 41 according to the prior art. The core 40 is composed of an inner ring 44 and an outer ring 45 connected together by an annular spacer 43 extending in a plane perpendicular to the axis of the core, imparting an H-shaped cross-section thereto. The core 40 presents in each of its sides 42 an annular groove of which the bottom is formed by the spacer. The annular groove is a particular shape of a gap in the side of the core.

FIGS. 5A and 5B illustrate a third embodiment of a core 50 and a wound tape 31 according to the prior art. The core 50 is composed of an inner ring and an outer ring connected together by a multiplicity of spacers 54 extending in axial planes and defining between them openings 53 disposed circumferentially. These spacers can be added to the median spacer in FIGS. 4A and 4B.

It is important to dedicate one dispenser, and more particularly one mandrel, to a particular type of tape in a given application for reasons of safety (medical field) and, more generally, for reasons of user satisfaction.

The invention proposes the technical solution described below.

For a proper understanding of the invention, it will be useful to adopt the following definitions:
The planes defined by the lateral faces of the tape and the core will be termed “limit planes of the core”.
The planes defined in the dispenser by the lateral faces of the tape and the core when the tape is correctly positioned in the dispenser will be termed “limit planes of the dispenser”.

The dispensers are designed so that the tapes naturally assume a fairly precise position between the two limit planes of the dispenser thereby facilitating optimum unwinding and cutting of the tape.
A structure will be described as being “in positive relief” relative to a limit plane of the dispenser if this structure presents one (or more) projecting element(s) on the side of the plane turned towards the roll, this (or these) element(s) being located more or less opposite the core positioned on the mandrel.
A structure will be described as being “in negative relief” relative to a limit plane of the dispenser if this structure presents one (or more) gap(s) on the side of the plane turned away from the roll, this (or these) element(s) being located more or less opposite the core positioned on the mandrel.

There are numerous existing embodiments of dispensers and some of these are well known. Purely for illustrative purposes, an example of a dispenser with fixed (or non-rotating) mandrel and an example with rotating mandrel according to the invention are depicted below.

The present invention involves furnishing a dispenser with means intended to automatically restrict the use of the dispenser to one type of tape, or to one class of tapes. Thus, a dispenser according to the invention includes means which may only be compatible with certain types of tape cores which may or may not be known in the prior art.

In the remainder of the description, the supporting structure can be composed of one or more parts which may be mobile, pivoted or connected together in different ways.

A component of the dispenser, such as the supporting structure or the rotating mandrel, can be fitted with projecting means such as a lug or boss for example, extending beyond the circumference of the mandrel, i.e. positioned beyond the mandrel relative to the axis X, and opposite the circumference of the core. These projecting means extend beyond at least one of the limit planes of the dispenser towards the mandrel, more generally towards the zone occupied by the tape core when it is positioned on the mandrel. In a non-limitative manner, this or these projecting means are substantially parallel to the axis X. The means are described as having “positive relief”. Projecting means of the lug or boss type are designed to be inserted into gaps, slots or grooves in the tape core (for example a core according to FIGS. 4A, 4B or 5A, 5B) when the latter is positioned to enable the roll to be correctly placed in the dispenser and to rotate therein. If the core does not match, it cannot be positioned correctly or the roll cannot turn.

Alternatively, a component of the dispenser, such as the supporting structure or the rotating mandrel, can be fitted with recessed means such as gaps beyond the circumference of the mandrel and opposite the circumference of the core. The means are described as having “negative relief”. Cores presenting lugs extending outside the limit plane of the core can only be placed correctly in the dispenser in the case where the lugs are sufficiently small and are positioned appropriately for insertion into the gaps. Here again, rolls having an unsuitable core will defy correct placement in the dispenser or may not rotate therein.

Combined solutions with positive relief and negative relief are also possible.

In the case of means positioned on the supporting structure, particularly on a wall substantially perpendicular to the axis X, the core must be compatible with the projecting or recessed means so as to be capable of correct placement on the mandrel and to be able to rotate about the mandrel or to turn with the mandrel. With projecting means, cores incorporating a central annular groove on the axis of the core will be used so as to permit free rotation of the core. Recessed means on the supporting structure will include an annular groove or a groove on at least an arc of circle centred on the axis X in the case where the wall is not perpendicular to the axis X or the wall only comes into contact with part of the side of the core.

For means positioned on a rotating mandrel, the core must be compatible with the projecting or recessed means so as to be capable of correct placement on the mandrel. In this instance, the core can be fixed in relation to the mandrel because the mandrel is rotatable.

The projecting or recessed means are components of the detection means enabling one type of tape to be dedicated to one type of dispenser.

The embodiments below will help to illustrate the invention without thereby limiting it.

FIGS. 6A, 6B and 6C depict embodiments of dispensers with non-rotating (for example fixed) mandrel according to the invention.

Unlike the dispenser according to the current state of the art described in FIGS. 1A and 1B, the supporting structure includes, around the fixed mandrel 61 and more particularly radially beyond the mandrel relative to the axis X, at least one element which is either projecting (FIGS. 6A and 6B) and extends beyond one of the limit planes towards the location to be occupied by the core (positive relief), or recessed (FIG. 6C) in relation to the limit plane of the dispenser (negative relief).

FIG. 6A illustrates the case where the detection means include several lugs 62 ; these are placed in a ring defined by two circles of radius Rmin and Rmax centred on the axis of rotation X of the mandrel 63. Only tape cores having an annular groove centred on the axis X on one of their sides, the annular groove having an inner radius Rr min less than Rmin and an outer radius Rr max greater than Rmax, can be positioned correctly in the dispenser and can rotate therein. The lugs are dimensioned so as to engage in the annular groove without undue friction on the core liable to impede rotation of the roll.

For example, an H-section core according to FIGS. 4A and 4B is compatible with this type of dispenser, provided that the detection means are correctly sized. However, a solid core according to FIGS. 3A and 3B cannot be placed correctly in the dispenser. A core incorporating at least one axial spacer according to FIGS. 5A and 5B can be placed in the dispenser, but cannot rotate therein.

FIG. 6B illustrates the case where the detection means include a cylindrical tube portion 65 having the same axis as the mandrel and placed on a ring defined by two radii Rmin and Rmax. As in the case depicted in FIG. 6A, only tape rolls in which the core has a central annular groove on axis X on one of its sides, the annular groove having an inner radius Rr min less than Rmin and an outer radius Rr max greater than Rmax, can be positioned correctly in the dispenser and rotate therein. The tube portion is dimensioned so as to engage in the annular groove without undue friction on the core liable to impede rotation of the tape roll.

Here again, an H-section core according to FIG. 4 is compatible with this type of dispenser, provided that its detection means are dimensioned correctly, whereas a solid core according to FIG. 3 cannot be placed correctly in the dispenser. A core with axial spacer(s) according to FIGS. 5A and 5B can be placed in the dispenser depending on the position of the spacers, but cannot rotate therein.

The tube portion in FIG. 6B can be replaced by a full tube.

FIG. 6C illustrates the case where the detection means incorporate an annular groove 64 centred on the axis X to a given depth in the wall of the supporting structure and delineated by the radii Rr min and Rr Max. Cores which incorporate lugs extending beyond the limit plane of the core and having an axial dimension greater than the depth of the groove 64 and/or a radial position not strictly between the radii Rr min and Rr max cannot be positioned correctly in the dispenser.

Thus, a particular case of a core compatible with a dispenser incorporating detection means as illustrated in FIG. 6C can be as follows: a core incorporating on one of its sides a lug or a complete or partial tube having an axial dimension less than the depth of the groove 64 and located on a central ring on the axis X of radii Rmin and Rmax, Rmin being greater than Rr min and Rmax being less than Rr max.

FIGS. 7A and 7B illustrate two new embodiments applicable to the case of a dispenser with rotating mandrel in which the recessed or projecting elements (gaps or lugs, etc.) are associated with the rotating mandrel and turn with it.

In FIG. 7A, the mandrel 70 is provided with two journals 74 placed on the axis X and serving to position the mandrel in the specific slots of 22 of the dispenser in FIG. 2A. The mandrel 70 is provided with lugs 71. These lugs are mounted on arms 73 which extend from the journals 74. The lugs are located on a circle of radius Rc concentric with the axis of the mandrel, and they extend beyond the limit plane of the dispenser towards the space to be occupied by the core (positive relief) and are of a suitable length and thickness and positioned to facilitate insertion into the gaps or grooves of compatible cores.

An H-section core according to FIGS. 4A and 4B is compatible with this type of dispenser, provided that the gaps or grooves in the core are correctly sized to permit insertion of the lugs on the mandrel 70, whereas a solid core according to FIG. 3 cannot be placed correctly in this type of dispenser.

A core with axial spacer(s) according to FIGS. 5A and 5B is also compatible, provided that the axial spacers are positioned and sized appropriately relative to the lugs, and particularly that the axial spacers and the lugs are positioned in an alternating fashion. This core with axial spacer(s) cannot rotate about the mandrel, but this is of no functional consequence because the mandrel is rotatable in this case.

By modifying the number of lugs and their angles relative to each other, it is possible to ensure selectivity of the tape via its core in relation to the gaps presented by the latter and even to provide a veritable automatic coding system for the tape.

FIG. 7B illustrates another embodiment of a rotating mandrel according to the invention. The mandrel 70 is provided with detection means including a disc 72 perpendicular to its axis and having a diameter greater than the diameter of the mandrel, on a face of the principal cylinder 25 of the mandrel. This disc defines one of the limit planes of the given dispenser. The detection means incorporate lugs 73 disposed on the face of this disk on the mandrel side, preventing the core from being positioned correctly if the core has no compatible grooves or gaps on the corresponding side.

An H-section core according to FIG. 4 is compatible with this type of dispenser, provided that the annular groove is sized and positioned correctly relative to the lugs 73. However, a solid core according to FIG. 3 cannot be placed correctly in the dispenser.

A core with axial spacer(s) according to FIG. 5 is also compatible, provided that the axial spacer(s) is (are) appropriately positioned and sized relative to the lugs, i.e. a lug can be placed between two axial spacers.

It is also possible to replace the lugs 73 by a full or partial tube concentric with the axis of the mandrel, similar to element 63 in FIG. 6B.

Of course the disc 72 is not necessarily circular or truly flat and its shape can vary. The term disc is to be understood in this extended sense.

It is thus possible to dedicate one mandrel according to the invention to one core. The user's attention is not required when placing a tape roll on the mandrel, because according to the invention placement or rotation is only possible provided that the core is compatible with the device.

The embodiments valid for the case of a dispenser with non-rotating (for example fixed) mandrel such as those described in FIGS. 6A to 6C, apply to the case of dispensers with rotating mandrel.

In this case, the dispenser with rotating mandrel can include a supporting structure incorporating the detection means in one of FIGS. 6A to 6C: the cores which assume the correct position in such a dispenser with rotating mandrel are the same as the cores which assume the correct position in the case of a dispenser with fixed mandrel according to one of the embodiments in FIGS. 6A to 6C. These cores can rotate about the rotating mandrel.

The dispenser with rotating mandrel can also include a rotating mandrel according to one of the embodiments in FIGS. 7A and 7B incorporating the detection means in one of FIGS. 6A to 6C. In this case, the cores which assume the correct position on a rotating mandrel incorporating the detection means are
cores which assume the correct position on the fixed mandrel in FIGS. 6A to 6B, these cores being free in rotation about the rotating mandrel,
cores presenting on one of their sides a groove in the shape of an arc of circle centred on the axis X or counterpart gap in the tube portion 65 in FIG. 6B placed on a mandrel. These cores are then integral with the rotating mandrel in rotation.

In the case of FIG. 7B depicting a rotating mandrel incorporating detection means, it is possible to provide gaps and lugs located on a circle centred on the axis X. Compatible cores in this case are cores presenting gaps located on a circle centred on the axis X, correctly sized and positioned to permit insertion of the lugs on the mandrel, these cores also possibly incorporating lugs located on a circle centred on the axis X, correctly sized and positioned to be inserted into the gaps of the rotating mandrel.

The invention is not limited to the embodiments described above. Thus, in the foregoing examples, the detection means according to the invention are integral either with a part of the supporting structure or with the rotating mandrel, but they can be integral with any other part included in the dispenser. They can also be placed on a dedicated component ; for example the disc 72 in FIG. 7B need not be integral with the mandrel as here depicted in this figure, but could be a thin disc with a hole through its centre designed to slide onto one of the projections on the mandrel. Changing the disc would allow the dispenser to be adapted to different cores in a specific manner.

The invention also applies to cases where the dispenser is able to simultaneously dispense several tapes and can therefore have several mandrels or several tape positions on a mandrel.

1. Dispenser and tape roll combination, the dispenser including a supporting structure defining an axis X, and a mandrel (25, 63) extending on the axis X and receiving a core carrying the tape roll (ROL), so as to allow the latter to rotate on itself about the axis X, characterised in that the dispenser includes detection means facing the core and positioned radially beyond the mandrel relative to the axis X, said detection means and the core respectively presenting projections and/or gaps and gaps and/or projections positioned and dimensioned so as to permit insertion and rotation of the core in the dispenser, the detection means preventing the insertion or rotation of a core which is not compatible with the detection means.

2. Dispenser and tape roll combination according to claim 1, characterised in that the detection means are disposed opposite at least one side of the core, which presents said gaps and/or projections.

3. Dispenser and tape roll combination according to claim 2, characterised in that the detection means incorporate a wall substantially perpendicular to the axis X presenting in one of its faces, turned towards the mandrel, at least one gap receiving a suitable projection formed on a side of the core, said wall preventing the insertion or rotation of a core having an unsuitable projection.

4. Dispenser and tape roll combination according to any of claims 1 to 3, characterised in that the detection means incorporate at least one projection engaging, substantially parallel to the axis X, in an appropriate gap provided in a side of the core.

5. Dispenser and tape roll combination according to claim 1, characterised in that the detection means are positioned radially at a distance from the mandrel.

6. Tape roll dispenser designed to form part of the dispenser and tape roll combination according to claim 1, the dispenser including a supporting structure defining an axis X, and a mandrel (25, 63) extending on the axis X and designed to receive a core carrying a tape roll, so as to allow the latter to rotate on itself about the axis X, the dispenser including detection means positioned radially beyond the mandrel relative to the axis X and capable of cooperating with the core so as to allow the latter to be seated or to rotate correctly in the dispenser only if it has a shape compatible with the detection means.

7. Dispenser according to claim 6, characterised in that the detection means incorporate a wall substantially perpendicular to the axis X presenting in one of its faces, turned towards the mandrel, at least one gap designed to receive a suitable projection formed on a side of the core, said wall preventing the insertion or rotation of a core having an unsuitable projection.

8. Dispenser according to any of claims 6 to 7, characterised in that the detection means incorporate at least one projection designed to engage, substantially parallel to the axis X, in a suitable gap provided in a side of the core.

9. Dispenser according to claim 1, characterised in that the projection includes at least one lug.

10. Dispenser according to claim 6, characterised in that the projection includes at least one tube portion of axis X.

11. Dispenser according to claim 1, characterised in that the mandrel is mounted on the supporting structure so as to rotate about the axis X.

12. Dispenser according to claim 11, characterised in that the mandrel includes at least one arm carrying the projection.

13. Dispenser according to claim 11, characterised in that the mandrel includes a disc extending perpendicularly to the axis X and incorporating detection means.

14. Dispenser according to claim 6, characterised in that at least part of the detection means is integral with the supporting structure.

15. Dispenser according to claim 6, characterised in that at least part of the detection means is integral with the mandrel.

16. Tape roll designed to form part of the dispenser and tape roll combination according to any of claims 1 to 3 or 5, including a core which presents at least one projection designed to engage in a gap in a wall of the dispenser.

17. Tape roll designed to form part of the dispenser and tape roll combination according to claim 1, characterised in that the core presents at least one gap designed to receive a projection on the dispenser.

18. Tape roll according to claim 16, characterised in that the projection includes at least one lug.

19. Tape roll according to claim 16, characterised in that the projection includes at least one tube portion of axis X.
